(19) United States
(12) Patent Application Publication
(10) Pub. No.: US 2020/0198244 A1
(43) Pub. Date: Jun. 25, 2020

(54) THREE-DIMENSIONAL SHAPING APPARATUS, THREE-DIMENSIONAL SHAPING SYSTEM, AND THREE-DIMENSIONAL SHAPED ARTICLE PRODUCTION METHOD

(71) Applicant: SEIKO EPSON CORPORATION, Tokyo (JP)

(72) Inventor: Eizo TAKAHASHI, Asahi-mura, Nagano (JP)

(21) Appl. No.: 16/720,112

(22) Filed: Dec. 19, 2019

(30) Foreign Application Priority Data
Dec. 21, 2018 (JP) 2018-239193

(51) Int. Cl. B29C 64/386; B29C 64/106

(52) U.S. Cl. CPC B29C 64/386; B33Y 10/00; B29C 64/106

(57) ABSTRACT

A three-dimensional shaping apparatus includes an ejection portion ejecting a shaping material, a shaping stage where the shaping material ejected from the ejection portion is stacked, a moving mechanism changing a relative position of the ejection portion and the shaping stage, a data generation portion generating second shaping data for representing a shape of a three-dimensional shaped article including a shape representing a type of the shaping material using first shaping data and material data representing the type of the shaping material, and a controller controlling the ejection portion and the moving mechanism according to the second shaping data, thereby shaping the three-dimensional shaped article.

The present application is based on, and claims priority from JP Application Serial Number 2018-239193, filed on Dec. 21, 2018, the disclosure of which is hereby incorporated by reference herein in its entirety.

### BACKGROUND

### 1. Technical Field

The present disclosure relates to a three-dimensional shaping apparatus, a three-dimensional shaping system, and a three-dimensional shaped article production method.

### 2. Related Art

For example, JP-A-2006-192710 (Patent Document 1) discloses a method for producing a three-dimensional shaped article by extruding a molten thermoplastic material onto a base from an extrusion nozzle scanning according to preset shape data, and further stacking a molten material on the material cured on the base.

When a three-dimensional shaped article is recycled, it is required that a type of a material used in the shaping be easily identifiable. However, in the method described in Patent Document 1, a case where the three-dimensional shaped article is recycled is not taken into consideration.

### SUMMARY

The present application provides a technique for making the type of the material used in the shaping easily identifiable from the three-dimensional shaped article.

According to an aspect of the present disclosure, a three-dimensional shaping apparatus is provided. This three-dimensional shaping apparatus includes an ejection portion ejecting a shaping material, a shaping stage where the shaping material ejected from the ejection portion is stacked, a moving mechanism changing a relative position of the ejection portion and the shaping stage, a data generation portion generating second shaping data for representing a shape of a three-dimensional shaped article including a shape representing a type of the shaping material using first shaping data and material data representing the type of the shaping material, and a controller controlling the ejection portion and the moving mechanism according to the second shaping data, thereby shaping the three-dimensional shaped article.

### BRIEF DESCRIPTION OF THE DRAWINGS

FIG. 1 is an explanatory view showing a schematic configuration of a three-dimensional shaping apparatus in a first embodiment.

FIG. 2 is an explanatory view showing a schematic configuration of an ejection unit in the first embodiment.

FIG. 3 is a perspective view showing a configuration of a groove formed face of a flat screw in the first embodiment.

FIG. 4 is a top view showing a configuration of a screw counter face of a barrel in the first embodiment.

FIG. 5 is a block diagram showing a schematic configuration of a data processing portion in the first embodiment.

FIG. 6 is a flowchart showing contents of a shaping process in the first embodiment.

FIG. 7 is an explanatory view showing one example of an operation screen displayed in a display portion.

FIG. 8 is an explanatory view showing one example of first shaping data and second shaping data.

FIG. 9 is an explanatory view showing a three-dimensional shaped article shaped according to the second shaping data.

FIG. 10 is an explanatory view showing a schematic configuration of a three-dimensional shaping apparatus in a second embodiment.

FIG. 11 is an explanatory view showing a schematic configuration of a three-dimensional shaping system as another embodiment.

### DESCRIPTION OF EXEMPLARY EMBODIMENTS

### A. First Embodiment

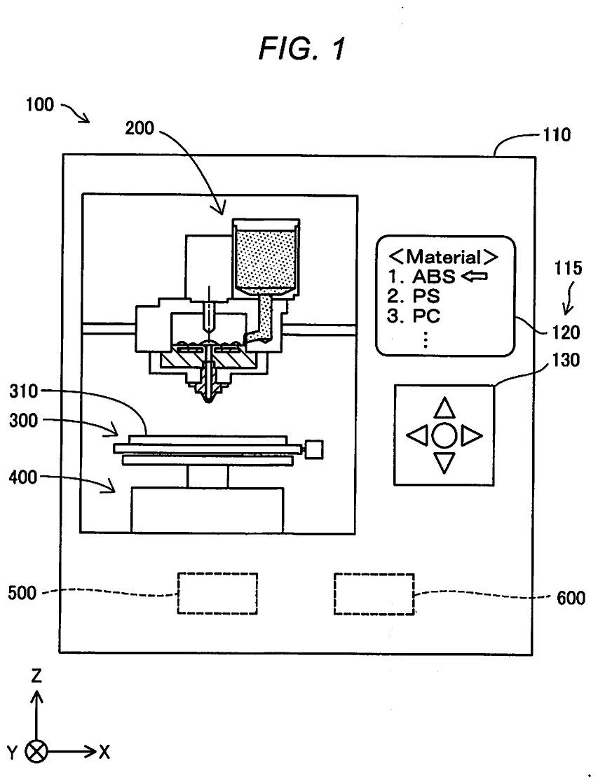

FIG. 1 is an explanatory view showing a schematic configuration of a three-dimensional shaping apparatus 100 in a first embodiment. In FIG. 1, arrows along the X, Y, and Z directions orthogonal to one another are shown. The X direction and the Y direction are directions along the horizontal direction, and the Z direction is a direction along the vertical direction. In also the other drawings, arrows along the X, Y, and Z directions are shown as appropriate. The X, Y, and Z directions in FIG. 1 and the X, Y, and Z directions in the other drawings indicate the same directions.

The three-dimensional shaping apparatus 100 in this embodiment includes an ejection unit 200, a shaping stage 300, a moving mechanism 400, a controller 500, and a data processing portion 600. The ejection unit 200, the shaping stage 300, the moving mechanism 400, the controller 500, and the data processing portion 600 are housed in a casing 110. The casing 110 is provided with a material designation portion 115 for designating a type of a shaping material used for shaping a three-dimensional shaped article by a user.

In this embodiment, the material designation portion 115 is constituted by a display portion 120 and an operation portion 130. In the display portion 120, various information regarding the three-dimensional shaping apparatus 100 is displayed. The display portion 120 in this embodiment is constituted by a liquid crystal display. The operation portion 130 is constituted by a button for operating the three-dimensional shaping apparatus 100. The display portion 120 and the operation portion 130 may be constituted as one body by constituting the display portion 120 by a touch panel.

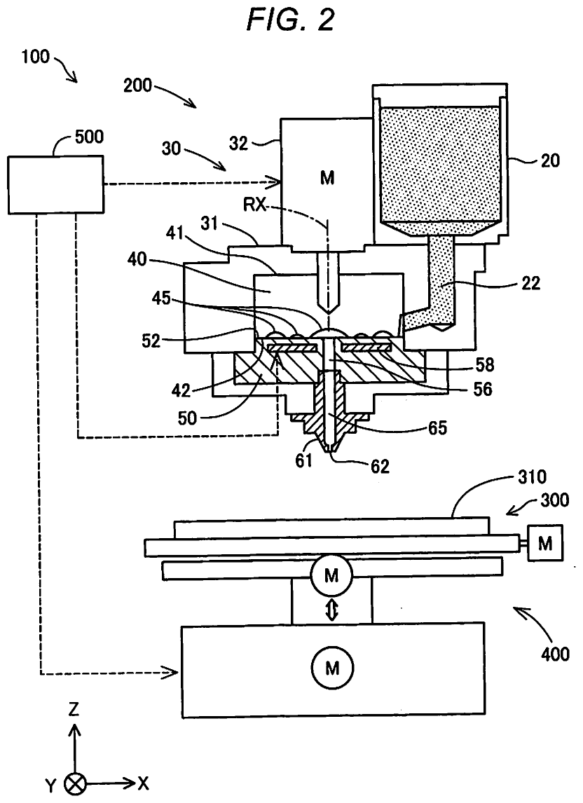

The three-dimensional shaping apparatus 100 shapes a three-dimensional shaped article having a desired shape by driving the moving mechanism 400 so as to change the relative position of the ejection unit 200 and the shaping stage 300 while ejecting the shaping material toward the shaping stage 300 from a nozzle 61 provided in the ejection unit 200 under the control of the controller 500, thereby stacking the shaping material on the shaping stage 300. The ejection unit 200 is sometimes referred to as “ejection portion”. A detailed configuration of the ejection unit 200 will be described later with reference to FIG. 2.

The shaping stage 300 has a shaping face 310 opposed to the nozzle 61. On the shaping face 310, the shaping material ejected from the nozzle 61 is stacked. In this embodiment, the shaping stage 300 is supported by the moving mechanism 400.

The moving mechanism 400 changes the relative position of the ejection unit 200 and the shaping stage 300. In this embodiment, the moving mechanism 400 moves the shaping stage 300 with respect to the ejection unit 200. The moving mechanism 400 in this embodiment is constituted by a three-axis positioner for moving the shaping stage 300 in three axis directions of the X, Y, and Z directions by driving forces of three motors. Each motor drives under the control of the controller 500. The moving mechanism 400 may not be configured to move the shaping stage 300, but may be configured to move the ejection unit 200 without moving the shaping stage 300. The moving mechanism 400 may be configured to move both the ejection unit 200 and the shaping stage 300.

The controller 500 is constituted by a computer including one or more processors, a main storage device, and an input/output interface for performing signal input/output to/from the outside. In this embodiment, the controller 500 exhibits various functions by execution of a program or a command read on the main storage device by the processor. The controller 500 may not be constituted by a computer, but may be constituted by a combination of a plurality of circuits.

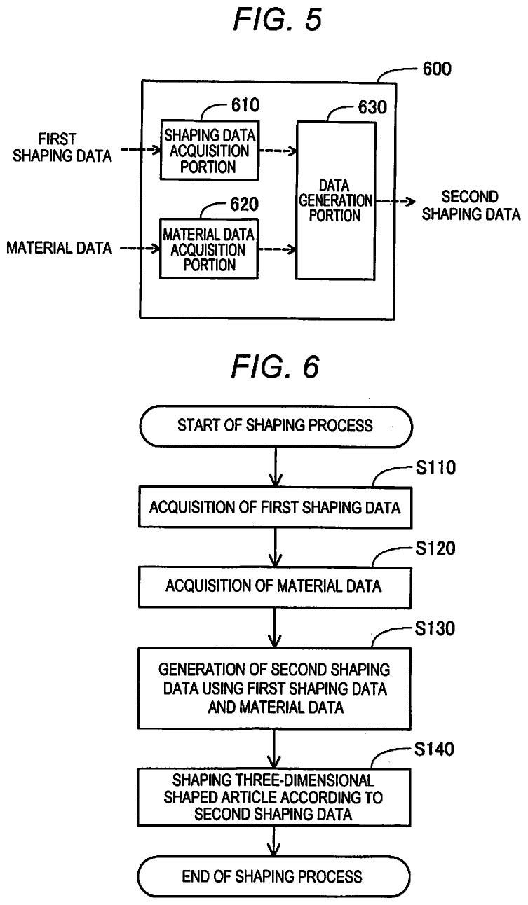

The data processing portion 600 is constituted by a computer including one or more processors, a main storage device, and an input/output interface for performing signal input/output to/from the outside. In this embodiment, the data processing portion 600 exhibits various functions by execution of a program or a command read on the main storage device by the processor. The data processing portion 600 may be constituted as a part of the controller 500. A detailed configuration of the data processing portion 600 will be described later with reference to FIG. 5.

FIG. 2 is an explanatory view showing a schematic configuration of the ejection unit 200 in this embodiment. The ejection unit 200 includes a material storage portion 20, a melting portion 30, and the nozzle 61. To the material storage portion 20, a material in a state of a pellet, a powder, or the like is fed. The material in this embodiment is an ABS resin in a pellet form. The material storage portion 20 in this embodiment is constituted by a hopper. The material storage portion 20 and the melting portion 30 are coupled to each other through a supply channel 22 provided below the material storage portion 20. The material fed to the material storage portion 20 is supplied to the melting portion 30 through the supply channel 22.

The melting portion 30 includes a screw case 31, a driving motor 32, a flat screw 40, and a barrel 50. The melting portion 30 melts at least a part of the material in a solid state supplied from the material storage portion 20 to form a shaping material in a paste form having fluidity, and supplies the shaping material to the nozzle 61. The flat screw 40 is sometimes simply referred to as “screw”.

The screw case 31 houses the flat screw 40. To an upper face of the screw case 31, the driving motor 32 is fixed. A rotating shaft of the driving motor 32 is coupled to an upper face 41 of the flat screw 40.

The flat screw 40 has a substantially columnar shape whose height in a direction along a central axis RX is smaller than the diameter. The flat screw 40 is disposed in the screw case 31 so that the central axis RX becomes parallel to the Z direction. The flat screw 40 rotates around the central axis RX in the screw case 31 due to a torque generated by the driving motor 32.

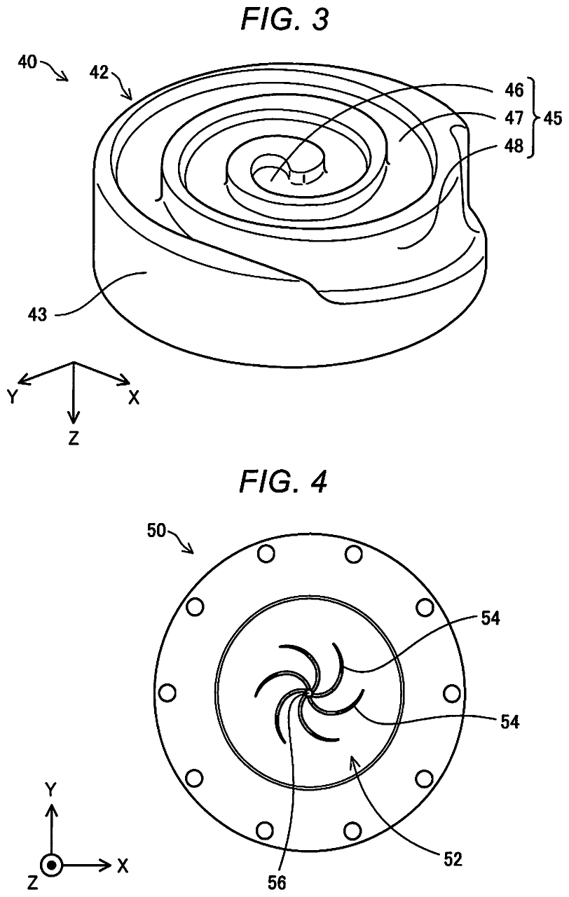

The flat screw 40 has a groove formed face 42 at an opposite side to the upper face 41 in a direction along the central axis RX. In the groove formed face 42, a groove portion 45 is formed. A detailed shape of the groove formed face 42 of the flat screw 40 will be described later with reference to FIG. 3.

The barrel 50 is provided below the flat screw 40. The barrel 50 has a screw counter face 52 opposed to the groove formed face 42 of the flat screw 40. The barrel 50 has a built-in heater 58 at a position opposed to the groove portion 45 of the flat screw 40. The temperature of the heater 58 is controlled by the controller 500. The heater 58 is sometimes referred to as “heating portion”.

At the center of the screw counter face 52, a communication hole 56 is provided. The communication hole 56 communicates with the nozzle 61. A detailed shape of the screw counter face 52 of the barrel 50 will be described later with reference to FIG. 4.

The nozzle 61 is provided with a nozzle hole 62 and a nozzle channel 65 communicating with the nozzle hole 62. The nozzle hole 62 is provided at a tip portion of the nozzle 61. The nozzle hole 62 is a portion with a reduced channel cross section provided at an end portion at a side communicating with the atmosphere of the nozzle channel 65. The nozzle channel 65 communicates with the communication hole 56 of the melting portion 30. The forming material supplied to the nozzle 61 from the melting portion 30 is ejected from the nozzle hole 62.

FIG. 3 is a perspective view showing a configuration of the groove formed face 42 of the flat screw 40 in this embodiment. The flat screw 40 shown in FIG. 3 is shown in a state where the vertical positional relationship shown in FIG. 2 is reversed for facilitating the understanding of the technique. In the groove formed face 42 of the flat screw 40, the groove portion 45 is formed as described above. The groove portion 45 includes a central portion 46, a spiral portion 47, and a material introduction portion 48.

The central portion 46 is a circular recess formed around the central axis RX of the flat screw 40. The central portion 46 is opposed to the communication hole 56 provided in the barrel 50.

The spiral portion 47 is a groove extending in a spiral shape so as to draw an arc toward the outer circumference of the groove formed face 42 with the central portion 46 as the center. The spiral portion 47 may be configured to extend in an involute curve shape or in a helical shape. One end of the spiral portion 47 is coupled to the central portion 46. The other end of the spiral portion 47 is coupled to the material introduction portion 48.

The material introduction portion 48 is a groove wider than the spiral portion 47 provided at the outer circumference of the groove formed face 42. The material introduction portion 48 is continuous to a side face 43 of the flat screw 40. The material introduction portion 48 introduces the material supplied from the material storage portion 20 to the spiral portion 47 through the supply channel 22. In FIG. 3, a form in which a single streak of spiral portion 47 and a single streak of material introduction portion 48 are provided toward the outer circumference from the central portion 46 of the flat screw 40 is shown, however, a plurality of streaks of spiral portions 47 and a plurality of streaks of material introduction portions 48 may be provided toward the outer circumference from the central portion 46 of the flat screw 40.

FIG. 4 is a top view showing a configuration of the screw counter face 52 of the barrel 50 in this embodiment. As described above, at the center of the screw counter face 52, the communication hole 56 communicating with the nozzle 61 is formed. Around the communication hole 56 in the screw counter face 52, a plurality of guide grooves 54 are formed. One end of each of the guide grooves 54 is coupled to the communication hole 56, and each guide groove 54 extends in a spiral shape toward the outer circumference of the screw counter face 52 from the communication hole 56. Each guide groove 54 has a function of guiding the shaping material to the communication hole 56.

According to the configuration of the ejection unit 200 described above, the material fed to the material storage portion 20 passes through the supply channel 22 and is supplied to the material introduction portion 48 from the side face 43 of the rotating flat screw 40. The material supplied into the material introduction portion 48 is conveyed into the spiral portion 47 by the rotation of the flat screw 40.

At least a part of the material conveyed into the spiral portion 47 is melted by the rotation of the flat screw 40 and heating by the built-in heater 58 in the barrel 50 to become the shaping material in a paste form having fluidity.

By the rotation of the flat screw 40, the shaping material is conveyed to the central portion 46 in the spiral portion 47. The shaping material conveyed to the central portion 46 is sent out to the nozzle hole 62 through the nozzle channel 65 from the communication hole 56, and ejected to the shaping stage 300 from the nozzle hole 62. In this manner, the shaping material is stacked on the shaping stage 300, whereby a three-dimensional shaped article is shaped.

FIG. 5 is a block diagram showing a schematic configuration of the data processing portion 600. The data processing portion 600 includes a shaping data acquisition portion 610, a material data acquisition portion 620, and a data generation portion 630. The shaping data acquisition portion 610 acquires first shaping data representing a shape of a three-dimensional shaped article. The material data acquisition portion 620 acquires material data representing a type of a shaping material to be used for shaping the three-dimensional shaped article. The material data can also be said to be data representing a type of a material to be fed to the material storage portion 20. The data generation portion 630 generates second shaping data representing the shape of the three-dimensional shaped article including a shape representing the type of the shaping material using the first shaping data and the material data.

FIG. 6 is a flowchart showing contents of a shaping process for producing a three-dimensional shaped article in this embodiment. This process is executed when a predetermined start operation is performed by a user for the operation portion 130 provided in the three-dimensional shaping apparatus 100 or a computer coupled to the three-dimensional shaping apparatus 100.

First, in Step S110, the shaping data acquisition portion 610 acquires first shaping data. In this embodiment, the shaping data acquisition portion 610 acquires first shaping path data PD1 for shaping a three-dimensional shaped article as the first shaping data. The first shaping path data PD1 are, for example, data representing the moving path of the nozzle 61 with respect to the shaping stage 300, the moving speed of the nozzle 61 with respect to the shaping stage 300, or the ejection amount of the shaping material from the nozzle 61. STL format or AMF format data for representing the shape of the three-dimensional shaped article are converted into the first shaping path data PD1 by a slicer. The shaping data acquisition portion 610 acquires the first shaping path data PD1 from a computer coupled to the three-dimensional shaping apparatus 100 or a recording medium via an input/output interface. The acquired first shaping data are transmitted to the data generation portion 630.

Subsequently, in Step S120, the material data acquisition portion 620 acquires material data. In this embodiment, a list of shaping materials stored in advance in a memory of the data processing portion 600 is displayed in the display portion 120. By operating the operation portion 130 by a user, a shaping material to be used for shaping the three-dimensional shaped article is designated from the list of the shaping materials displayed in the display portion 120. The material data acquisition portion 620 acquires material data representing the type of the shaping material designated by the user. The acquired material data are transmitted to the data generation portion 630.

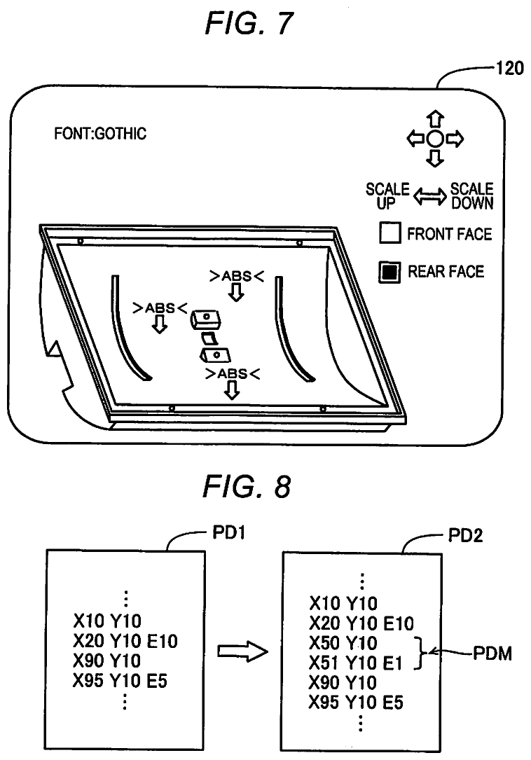

FIG. 7 is an explanatory view showing one example of an operation screen displayed in the display portion 120. With reference to FIGS. 6 and 7, in this embodiment, the type of the shaping material is represented by a letter or a symbol. For example, when an ABS resin is used, it is represented by “>ABS<” using a display symbol or an abbreviation specified in JIS K 6899-1 (ISO 1043-1) and also using a display format specified in JIS K 6999 (ISO 11469). This letter or symbol is shown by forming a part of the three-dimensional shaped article in a projecting shape. In order to form this letter or symbol, in the material data, other than information regarding the type of the shaping material, information regarding the font and size of the letter or symbol, and information regarding the position where the letter or symbol is formed in the three-dimensional shaped article are included. By operating the operation portion 130 by a user while confirming the operation screen displayed in the display portion 120, the font and size of the letter or symbol, and the position where the letter or symbol is formed in the three-dimensional shaped article are designated as well as the type of the shaping material.

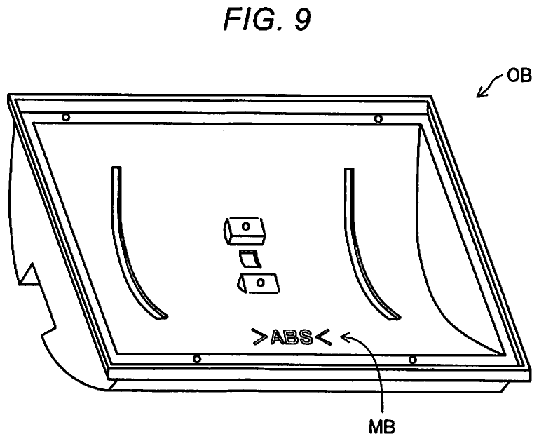

FIG. 8 is an explanatory view showing one example of the first shaping data and the second shaping data. With reference to FIGS. 6 and 8, in Step S130, the data generation portion 630 generates the second shaping data using the first shaping data and the material data. In this embodiment, the data generation portion 630 first generates a material shaping path element PDM for shaping the shape representing the type of the shaping material using the material data. Subsequently, the data generation portion 630 generates second shaping path data PD2 as the second shaping data by adding the material shaping path element PDM to the first shaping path data PD1.

FIG. 9 is an explanatory view showing the three-dimensional shaped article shaped according to the second shaping data. With reference to FIGS. 6 and 9, in Step S140, the controller 500 controls the ejection unit 200 and the moving mechanism 400 according to the second shaping path data PD2, thereby shaping a three-dimensional shaped article OB having a shape MB representing the type of the shaping material. In this embodiment, by shaping the three-dimensional shaped article OB according to the second shaping path data PD2 in which the material shaping path element PDM is added to the first shaping path data PD1, the shape MB representing the type of the shaping material is formed in a projecting shape at a face of the three-dimensional shaped article OB. The projecting shape means a state where the shape MB representing the type of the shaping material projects above the peripheral face in the three-dimensional shaped article OB so that the volume of the three-dimensional shaped article OB represented by the second shaping data becomes larger than the volume of the three-dimensional shaped article represented by the first shaping data.

According to the three-dimensional shaping apparatus 100 of this embodiment described above, the data generation portion 630 generates the second shaping data for representing the shape of the three-dimensional shaped article OB including the shape MB representing the type of the shaping material, and the controller 500 shapes the three-dimensional shaped article OB according to the second shaping data. Therefore, since the three-dimensional shaped article OB in which the type of the shaping material used for shaping can be easily identified is shaped, the three-dimensional shaped article OB can be easily made recyclable. In particular, in this embodiment, in a designing step, even if shape data of the three-dimensional shaped article OB including the shape MB representing the type of the shaping material are not generated, the three-dimensional shaped article OB in which the type of the shaping material used for shaping can be easily identified is shaped, and therefore, even when the type of the shaping material is changed due to design change or the like, time and effort for changing the shape data going back to the designing step can be reduced.

Further, in this embodiment, the type of the shaping material can be designated using the material designation portion 115, and therefore, the material data can be easily set by one three-dimensional shaping apparatus 100.

In this embodiment, an ABS resin material in a pellet form is used, however, as the material used in the ejection unit 200, for example, a material shaping a three-dimensional shaped article using any of various materials such as a material having thermoplasticity, a metal material, or a ceramic material as a main material can also be adopted. Here, the “main material” refers to a material mainly used for forming the shape of the three-dimensional shaped article and means a material whose content is 50 wt % or more in the three-dimensional shaped article. In the above-mentioned shaping material, a material obtained by melting such a main material singly, or a material in a paste form obtained by melting a part of the components contained together with the main material is included.

When a material having thermoplasticity is used as the main material, the shaping material is formed by plasticization of the material in the melting portion 30. The “plasticization” refers to melting by applying heat to the material having thermoplasticity.

As the material having thermoplasticity, for example, any one or a combination of two or more of the following thermoplastic resin materials can be used.

### Examples of Thermoplastic Resin Material

general-purpose engineering plastics such as a polypropylene resin (PP), a polyethylene resin (PE), a polyacetal resin (POM), a polyvinyl chloride resin (PVC), a polyamide resin (PA), an acrylonitrile-butadiene-styrene resin (ABS), a polylactic acid resin (PLA), a polyphenylene sulfide resin (PPS), polyether ether ketone (PEEK), polycarbonate (PC), modified polyphenylene ether, polybutylene terephthalate, and polyethylene terephthalate, and engineering plastics such as polysulfone, polyethersulfone, polyphenylene sulfide, polyarylate, polyimide, polyamideimide, polyetherimide, and polyether ether ketone

In the material having thermoplasticity, a pigment, a metal, a ceramic, or other than these, an additive such as a wax, a flame retardant, an antioxidant, or a heat stabilizer, or the like may be mixed. The material having thermoplasticity is converted into a molten state by plasticization due to the rotation of the flat screw 40 and heating by the heater 58 in the melting portion 30. The shaping material formed in this manner is cured by decreasing the temperature after being ejected from the nozzle hole 62.

The material having thermoplasticity is desirably injected from the nozzle hole 62 in a completely molten state by being heated to a temperature not lower than the glass transition point thereof. For example, an ABS resin has a glass transition point of about 120° C. and the temperature thereof when it is injected from the nozzle hole 62 is desirably about 200° C. In order to inject the shaping material in a high temperature state in this manner, a heater may be provided around the nozzle hole 62.

In the ejection unit 200, in place of the above-mentioned material having thermoplasticity, for example, the following metal material may be used as the main material. In this case, it is desirable that a component melting when forming the shaping material is mixed in a powder material obtained by pulverizing the following metal material, and the resulting material is fed to the melting portion 30.

### Examples of Metal Material

single metals such as magnesium (Mg), iron (Fe), cobalt (Co), chromium (Cr), aluminum (Al), titanium (Ti), copper (Cu), and nickel (Ni), or alloys containing one or more of these metals

### Examples of Alloy

a maraging steel, stainless steel, cobalt-chromium-molybdenum, a titanium alloy, a nickel alloy, an aluminum alloy, a cobalt alloy, and a cobalt-chromium alloy

In the ejection unit 200, in place of the above-mentioned metal material, a ceramic material can be used as the main material. As the ceramic material, for example, an oxide ceramic such as silicon dioxide, titanium dioxide, aluminum oxide, or zirconium oxide, a non-oxide ceramic such as aluminum nitride, or the like can be used. When a metal material or a ceramic material as described above is used as the main material, the shaping material placed in the shaping stage 300 may be cured by, for example, irradiation with a laser or sintering with hot air or the like.

The powder material of the metal material or the ceramic material to be fed to the material storage portion 20 maybe a mixed material obtained by mixing a plurality of types of single metal powders or alloy powders or ceramic material powders. Further, the powder material of the metal material or the ceramic material may be coated with, for example, a thermoplastic resin as exemplified above or a thermoplastic resin other than those exemplified above. In this case, the material may be configured to exhibit fluidity by melting the thermoplastic resin in the melting portion 30.

To the powder material of the metal material or the ceramic material to be fed to the material storage portion 20, for example, a solvent as described below can also be added. As the solvent, one type or a combination of two or more types selected from the following solvents can be used.

### Examples of Solvent

water, (poly)alkylene glycol monoalkyl ethers such as ethylene glycol monomethyl ether, ethylene glycol monoethyl ether, propylene glycol monomethyl ether, and propylene glycol monoethyl ether, acetate esters such as ethyl acetate, n-propyl acetate, iso-propyl acetate, n-butyl acetate, and iso-butyl acetate, aromatic hydrocarbons such as benzene, toluene, and xylene, ketones such as methyl ethyl ketone, acetone, methyl isobutyl ketone, ethyl n-butyl ketone, diisopropyl ketone, and acetyl acetone, alcohols such as ethanol, propanol, and butanol, tetra-alkyl ammonium acetates, sulfoxide-based solvents such as dimethyl sulfoxide and diethyl sulfoxide, pyridine-based solvents such as pyridine, γ-picoline, and 2,6-lutidine, tetra-alkyl ammonium acetates (for example, tetra-butyl ammonium acetate, etc.), ionic liquids such as butyl carbitol acetate, and the like

In addition thereto, for example, a binder as described below can also be added to the powder material of the metal material or the ceramic material to be fed to the material storage portion 20.

### Examples of Binder

an acrylic resin, an epoxy resin, a silicone resin, a cellulosic resin, or another synthetic resin, or PLA (polylactic acid), PA (polyamide), PPS (polyphenylene sulfide), PEEK (polyether ether ketone), or other thermoplastic resins

### B. Second Embodiment

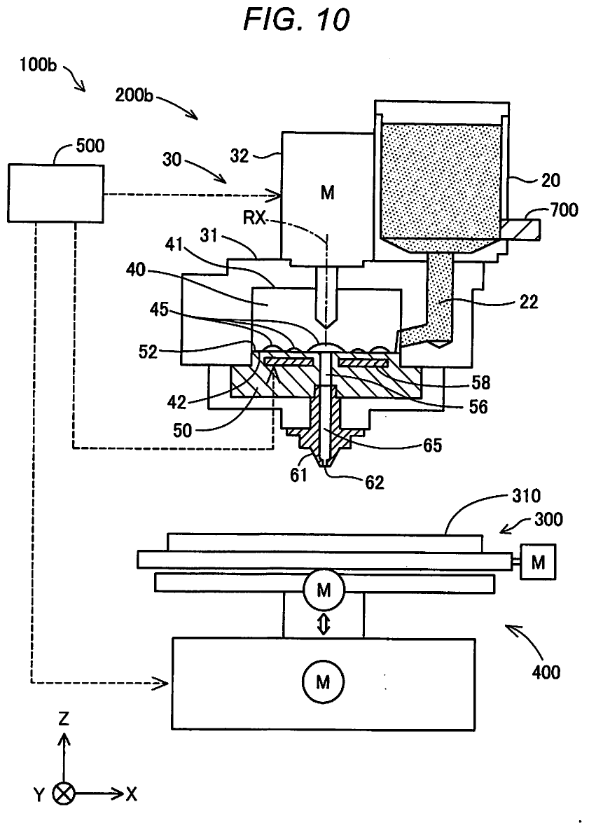

FIG. 10 is an explanatory view showing a schematic configuration of a three-dimensional shaping apparatus 100b in a second embodiment. The three-dimensional shaping apparatus 100b of the second embodiment is different from that of the first embodiment in that an ejection unit 200b includes a material identification portion 700 identifying a type of a shaping material, and a material data acquisition portion 620 acquires material data representing the type of the shaping material identified by the material identification portion 700. The other configuration is the same as that of the first embodiment shown in FIG. 1 unless otherwise described.

In this embodiment, the material identification portion 700 is provided in the material storage portion 20. As the material identification portion 700 in this embodiment, a Fourier transform infrared spectrometer identifying the type of a material by irradiating the material with infrared light and measuring the amount of transmitted or reflected light is used. The type of the shaping material identified by the material identification portion 700 is acquired as the material data by the material data acquisition portion 620.

According to the three-dimensional shaping apparatus 100b of this embodiment described above, the type of the material identified by the material identification portion 700 is acquired as the material data by the material data acquisition portion 620, and therefore, time and effort for designating the type of the shaping material by a user can be omitted. Due to this, the material data can be more easily set.

### C. Other Embodiments

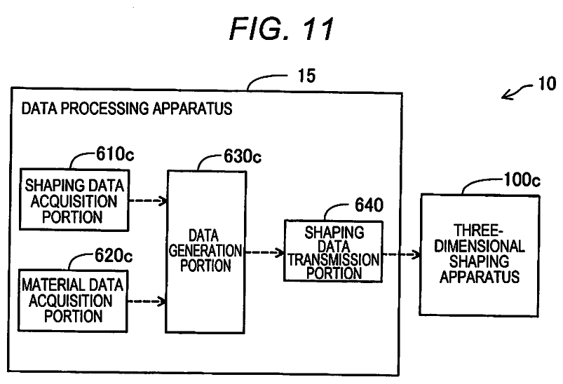

(C1) FIG. 11 is an explanatory view showing a schematic configuration of a three-dimensional shaping system 10 as another embodiment. The three-dimensional shaping system 10 includes a three-dimensional shaping apparatus 100c and a data processing apparatus 15. The configuration of the three-dimensional shaping apparatus 100c in the three-dimensional shaping system 10 is the same as the configuration in which the data processing portion 600 is excluded from the three-dimensional shaping apparatus 100 of the first embodiment. The data processing apparatus 15 includes a shaping data acquisition portion 610c, a material data acquisition portion 620c, a data generation portion 630c, and a shaping data transmission portion 640. The shaping data acquisition portion 610c, the material data acquisition portion 620c, and the data generation portion 630c have the same functions as the shaping data acquisition portion 610, the material data acquisition portion 620, and the data generation portion 630 in the data processing portion 600 of the first embodiment. The shaping data transmission portion 640 is configured to be able to communicate with the three-dimensional shaping apparatus 100c by wire or wirelessly, and transmits the second shaping data generated by the data generation portion 630c to the three-dimensional shaping apparatus 100c. In this embodiment, the data processing apparatus 15 is constituted by a computer including one or more processors, a main storage device, and an input/output interface for performing signal input/output to/from the outside. The data processing apparatus 15 exhibits various functions by execution of a program or a command read on the main storage device by the processor. Further, the three-dimensional shaping apparatus 100c may have a configuration in which the data processing portion 600 is excluded from the three-dimensional shaping apparatus 100b of the second embodiment, and the data processing apparatus 15 may have the same function as the data processing portion 600 of the second embodiment, and also may be configured to include the above-mentioned shaping data transmission portion 640. The configuration of the three-dimensional shaping apparatus 100c in the three-dimensional shaping system 10 maybe the same as the configuration in which the data processing portion 600 and the material designation portion 115 are excluded from the three-dimensional shaping apparatus 100 of the first embodiment, and the function of the material designation portion 115 may be realized by the data processing apparatus 15.

(C2) In the three-dimensional shaping apparatus 100 or 100b of each embodiment described above, the shape MB representing the type of the shaping material is formed in a projecting shape at a face of the three-dimensional shaped article OB. On the other hand, the shape MB representing the type of the shaping material may be formed in a recessed shape at a face of the three-dimensional shaped article OB. The recessed shape means a state where the shape MB representing the type of the material is recessed below the peripheral face in the three-dimensional shaped article OB so that the volume of the three-dimensional shaped article OB represented by the second shaping data becomes smaller than the volume of the three-dimensional shaped article represented by the first shaping data. The data generation portion 630 can generate the second shaping path data PD2 for forming the shape MB representing the type of the shaping material in a recessed shape at a face of the three-dimensional shaped article OB by dividing and editing the shaping path included in the first shaping path data PD1. In this case, abrasion of the shape MB representing the type of the shaping material can be made less likely to occur as compared with the form in which the shape MB representing the type of the shaping material is formed in a projecting shape at a face of the three-dimensional shaped article OB.

(C3) In the three-dimensional shaping apparatus 100 or 100b of each embodiment described above, the shape MB representing the type of the shaping material is represented by a letter or a symbol. On the other hand, the shape MB representing the type of the shaping material may be constituted by a barcode or a two-dimensional code. In the barcode or the two-dimensional code, other than information regarding the type of the material, various information such as production date, production site, and production conditions can be recorded. At the time of recycling, by acquiring such information through scanning of this barcode or two-dimensional code with a reader, the type or the like of the shaping material can be identified. In this case, more information can be added as compared with the form in which the shape MB representing the type of the shaping material is formed with a letter or a symbol.

(C4) In the three-dimensional shaping apparatus 100 or 100b of each embodiment described above, the first shaping path data PD1 is used as the first shaping data, and the second shaping path data PD2 is used as the second shaping data. On the other hand, the first shaping data and the second shaping data may be shape data representing a shape of a three-dimensional shaped article generated using a three-dimensional CAD or the like. In this case, for example, a function as a slicer is incorporated in the data generation portion 630, and the data generation portion 630 may generate the second shaping path data PD2 using the supplied shape data and material data.

(C5) In the three-dimensional shaping apparatus 100b of the second embodiment described above, the material storage portion 20 maybe constituted by a cartridge housing a shaping material. The apparatus may be configured such that the cartridge has a built-in chip in which the type of the housed shaping material is stored, and the material identification portion 700 identifies the type of the shaping material stored in the chip. The material identification portion 700 can identify the type of the shaping material stored in the chip by electrically coupling a connector of the cartridge and a connector provided in the three-dimensional shaping apparatus 100b. The information regarding the type of the shaping material identified by the material identification portion 700 is transmitted to the material data acquisition portion 620.

(C6) In each embodiment described above, the three-dimensional shaped article OB including the shape MB representing the type of the material is shaped using the three-dimensional shaping apparatus 100 or 100b, in which at least a part of the material is melted by the rotation of the flat screw 40 and heating by the built-in heater 58 in the barrel 50 to form the shaping material, and the formed shaping material is ejected from the nozzle 61 and stacked on the shaping stage 300. On the other hand, for example, the three-dimensional shaped article OB including the shape MB representing the type of the material may be shaped using various shaping systems such as an FDM (Fused Deposition Modeling) system in which a filament-like material is used, an inkjet system, a DMD (Direct Metal Deposition) system, or a powder bed fusion system.

### D. Other Aspects

The present disclosure is not limited to the above-mentioned embodiments, but can be realized in various aspects without departing from the gist thereof. For example, the present disclosure can also be realized in the following aspects. The technical features in the above-mentioned embodiments corresponding to technical features in the respective aspects described below may be appropriately replaced or combined for solving part or all of the problems of the present disclosure or achieving part or all of the effects of the present disclosure. Further, the technical features may be appropriately deleted unless they are described as essential features in the present specification.

(1) According to a first aspect of the present disclosure, a three-dimensional shaping apparatus is provided. This three-dimensional shaping apparatus includes an ejection portion ejecting a shaping material, a shaping stage where the shaping material ejected from the ejection portion is stacked, a moving mechanism changing a relative position of the ejection portion and the shaping stage, a data generation portion generating second shaping data for representing a shape of a three-dimensional shaped article including a shape representing a type of the shaping material using first shaping data and material data representing the type of the shaping material, and a controller controlling the ejection portion and the moving mechanism according to the second shaping data, thereby shaping the three-dimensional shaped article.

According to the three-dimensional shaping apparatus of this aspect, a three-dimensional shaped article including a shape representing a type of a shaping material is shaped. Therefore, the type of the material used in the shaping can be easily identified from the three-dimensional shaped article.

(2) The three-dimensional shaping apparatus of the above aspect may further include a material designation portion for designating the type of the shaping material, and the data generation portion may generate the second shaping data using the material data representing the type of the shaping material designated by the material designation portion.

According to the three-dimensional shaping apparatus of this aspect, the type of the shaping material can be designated using the material designation portion, and therefore, the material data can be easily set.

(3) The three-dimensional shaping apparatus of the above aspect may further include a material identification portion identifying the type of the shaping material by analyzing a component of the shaping material, and the data generation portion may generate the second shaping data using the material data representing the type of the shaping material identified by the material identification portion.

According to the three-dimensional shaping apparatus of this aspect, time and effort for designating the type of the shaping material by a user can be omitted, and therefore, the material data can be more easily set.

(4) In the three-dimensional shaping apparatus of the above aspect, the data generation portion may generate the second shaping data for representing the shape of the three-dimensional shaped article including a shape of a barcode or a two-dimensional code as the shape representing the type of the shaping material.

According to the three-dimensional shaping apparatus of this aspect, more information can be added as compared with the aspect in which the shape representing the type of the shaping material is formed with a letter or a symbol.

(5) In the three-dimensional shaping apparatus of the above aspect, the data generation portion may generate the second shaping data for representing the shape of the three-dimensional shaped article including the shape representing the type of the shaping material provided in a recessed shape at a face of the three-dimensional shaped article.

According to the three-dimensional shaping apparatus of this aspect, abrasion of the shape representing the type of the shaping material can be made less likely to occur as compared with the aspect in which the shape representing the type of the shaping material is provided in a projecting shape at a face of the three-dimensional shaped article.

(6) According to a second aspect of the present disclosure, a three-dimensional shaping system is provided. This three-dimensional shaping system includes a three-dimensional shaping apparatus and a data processing apparatus. The three-dimensional shaping apparatus includes an ejection portion ejecting a shaping material, a shaping stage where the shaping material ejected from the ejection portion is stacked, a moving mechanism changing a relative position of the ejection portion and the shaping stage, and a controller controlling the ejection portion and the moving mechanism, and the data processing apparatus includes a data generation portion generating second shaping data for representing a shape of a three-dimensional shaped article including a shape representing a type of the shaping material using first shaping data and material data representing the type of the shaping material, and a shaping data transmission portion transmitting the second shaping data to the three-dimensional shaping apparatus, and the controller of the three-dimensional shaping apparatus controls the ejection portion and the moving mechanism according to the second shaping data, thereby shaping the three-dimensional shaped article.

According to the three-dimensional shaping system of this aspect, a three-dimensional shaped article including a shape representing a type of a shaping material is shaped. Therefore, the type of the material used in the shaping can be easily identified from the three-dimensional shaped article.

(7) According to a third aspect of the present disclosure, a three-dimensional shaped article production method is provided. The three-dimensional shaped article production method includes acquiring first shaping data, acquiring material data representing a type of a shaping material, generating second shaping data for representing a shape of a three-dimensional shaped article including a shape representing the type of the shaping material using the first shaping data and the material data, and shaping the three-dimensional shaped article according to the second shaping data.

According to the three-dimensional shaped article production method of this aspect, a three-dimensional shaped article including a shape representing a type of a shaping material is shaped. Therefore, the type of the material used in the shaping can be easily identified from the three-dimensional shaped article.

The present disclosure can also be realized in various aspects other than the three-dimensional shaping apparatus. For example, it can be realized in aspects of a three-dimensional shaping system, a three-dimensional shaping apparatus controlling method, a three-dimensional shaped article production method, etc.

What is claimed is:

1. A three-dimensional shaping apparatus, comprising:
an ejection portion ejecting a shaping material;
a shaping stage where the shaping material ejected from the ejection portion is stacked;
a moving mechanism changing a relative position of the ejection portion and the shaping stage;
a data generation portion generating second shaping data for representing a shape of a three-dimensional shaped article including a shape representing a type of the shaping material using first shaping data and material data representing the type of the shaping material; and
a controller controlling the ejection portion and the moving mechanism according to the second shaping data, thereby shaping the three-dimensional shaped article.

2. The three-dimensional shaping apparatus according to claim 1, further comprising a material designation portion for designating the type of the shaping material, wherein
the data generation portion generates the second shaping data using the material data representing the type of the shaping material designated by the material designation portion.

3. The three-dimensional shaping apparatus according to claim 1, further comprising a material identification portion identifying the type of the shaping material by analyzing a component of the shaping material, wherein
the data generation portion generates the second shaping data using the material data representing the type of the shaping material identified by the material identification portion.

4. The three-dimensional shaping apparatus according to claim 1, wherein the data generation portion generates the second shaping data for representing the shape of the three-dimensional shaped article including a shape of a barcode or a two-dimensional code as the shape representing the type of the shaping material.

5. The three-dimensional shaping apparatus according to claim 1, wherein the data generation portion generates the second shaping data for representing the shape of the three-dimensional shaped article including the shape representing the type of the shaping material provided in a recessed shape at a face of the three-dimensional shaped article.

6. A three-dimensional shaping system, comprising a three-dimensional shaping apparatus and a data processing apparatus, wherein
the three-dimensional shaping apparatus includes:
an ejection portion ejecting a shaping material;
a shaping stage where the shaping material ejected from the ejection portion is stacked;
a moving mechanism changing a relative position of the ejection portion and the shaping stage; and
a controller controlling the ejection portion and the moving mechanism, and
the data processing apparatus includes:
a data generation portion generating second shaping data for representing a shape of a three-dimensional shaped article including a shape representing a type of the shaping material using first shaping data and material data representing the type of the shaping material; and
a shaping data transmission portion transmitting the second shaping data to the three-dimensional shaping apparatus, and
the controller of the three-dimensional shaping apparatus controls the ejection portion and the moving mechanism according to the second shaping data, thereby shaping the three-dimensional shaped article.

7. A three-dimensional shaped article production method, comprising:
acquiring first shaping data;
acquiring material data representing a type of a shaping material;
generating second shaping data for representing a shape of a three-dimensional shaped article including a shape representing the type of the shaping material using the first shaping data and the material data; and
shaping the three-dimensional shaped article according to the second shaping data.
